(19) United States
(12) Patent Application Publication
(10) Pub. No.: US 2019/0379230 A1
(43) Pub. Date: Dec. 12, 2019

(54) INCREASING EFFICIENCY IN WIRELESS CHARGERS

(71) Applicant: Google LLC, Mountain View, CA (US)

(72) Inventors: Xuelin Wu, Palo Alto, CA (US); Honggang Sheng, Milpitas, CA (US)

(21) Appl. No.: 16/004,768

(22) Filed: Jun. 11, 2018

(51) Int. Cl. H02J 7/02; H02J 50/12; H02J 7/06; H02J 50/80

(52) U.S. Cl. CPC H02J 7/025; H02J 50/12; H02J 7/008; H02J 7/027; H02J 50/80; H02J 7/06

(57) ABSTRACT

Methods, systems, and apparatus for high-efficiency wireless charging are presented. The system can include a transmitter for generating a transmitted power signal and a receiver for converting the transmitted power signal to a DC signal for charging a battery. The receiver can include (i) an inductive coil, which generates an AC signal in the presence of the transmitted power signal, (ii) a conversion circuit, which converts the AC signal generated by the coil to a DC output signal, (iii) a charging circuit comprising one or more switched capacitors, which converts the DC output signal to a DC charging signal, and (iv) a controller, which measures a signal of the battery indicating a charge level of the battery. Based on determining that the relationship between the DC charging signal and the signal of the battery satisfies the predetermined criterion, the controller generates a control signal to adjust the AC signal.

### TECHNICAL FIELD

This specification generally describes techniques for wirelessly charging batteries in electronic devices.

### BACKGROUND

Various electronic devices, such as smartphones, tablet computing devices, and wearable health monitors, include rechargeable batteries, such as Lithium ion batteries, for powering device operations. For some device configurations, the device's battery can be charged wirelessly through electromagnetic induction, enabling charging of the battery without physically connecting the electronic device to a power source. Inefficiencies in the wireless charging system can generate heat within the device, limiting charging currents and increasing overall charging times.

### SUMMARY

This specification generally describes techniques for improving efficiency in wireless charging systems. In some implementations, a battery-powered electronic device, such as a smartphone or tablet computer, includes a high-efficiency wireless receiver for charging the device battery without physically connecting the device to a power source. The wireless receiver can include an inductively-coupled coil, which generates an AC electrical signal in the presence of a transmitted power signal, where the transmitted power signal is a magnetic field generated by a nearby transmitting coil. The generated AC signal is converted to a DC signal by a conversion circuit of the receiver and then input to a high-efficiency charging circuit. The charging circuit converts the input signal to an appropriate voltage DC charging signal and provides the charging signal to the device battery. The high-efficiency charging circuit can be, for example, a switched-capacitor circuit with a fixed step-down voltage conversion ratio (e.g., a 2:1 voltage divider). In some cases, the charging circuit performs voltage conversion with an efficiency of 97-percent or greater, although other efficiencies may also be achieved (e.g., greater than 85-percent, 90-percent, or 95-percent efficient). The high-efficiency of the charging circuit reduces power loss and heat generation in the wireless receiver, enabling it to support higher charging currents and faster battery charging times.

Over the course of a charging cycle, the charge level of a depleted battery will gradually increase. To adjust the generated DC charging signal in response to the changing battery charge level, the receiver can send a message to the transmitter to adjust one or more characteristics of the transmitted power signal. For example, the receiver can request the transmitter to adjust an amplitude, frequency, and/or other waveform characteristic of the magnetic field generated by the transmitting coil. The receiver can communicate with the transmitter by modulating the receiver-side impedance of the inductively-coupled coils or by exchanging data over a dedicated wireless communication channel.

In some implementations, a receiver for a wireless charging system includes an inductive coil, a conversion circuit, a charging circuit, and a controller. The receiver inductive coil is configured to generate an AC signal in the presence of a magnetic field, and the conversion circuit is configured to convert the AC signal generated by the inductive coil to a DC output signal, where a voltage level of the DC output signal is a function of one or more characteristics of the AC signal generated by the inductive coil. The charging circuit is configured to convert the DC output signal to a DC charging signal, where the voltage level of the DC charging signal has a fixed relationship to the voltage level of the DC output signal and the voltage level of the DC charging signal is less than the voltage level of the DC output signal. The charging circuit is further configured to provide the DC charging signal to a battery. The controller is configured to (i) measure a signal of the battery that corresponds to a charge level of the battery; (ii) based on the signal of the battery, determine that a relationship between the DC charging signal and the signal of the battery satisfies a predetermined criterion; and (iii) based on determining that the relationship between the DC charging signal and the signal of the battery satisfies the predetermined criterion, generate a control signal to adjust the AC signal.

Some implementations include one or more of the following features. The receiver conversion circuit can include an impedance matching circuit, a rectifying circuit, and a voltage regulating circuit. In some implementations, the rectifying circuit includes one or more of a full-wave diode bridge rectifier or an active switching rectifier. In some implementations, the voltage regulating circuit includes one or more of a linear voltage regulator or a switching voltage regulator.

In some implementations, the voltage level of the DC output signal generated by the receiver conversion circuit is determined based on one or more of a voltage level or a frequency of the AC signal generated by the receiver inductive coil.

In some implementations, the receiver charging circuit includes one or more switched capacitor circuits.

In some implementations, the voltage level of the DC charging signal generated by the receiver charging circuit is one half or one quarter of the voltage level of the DC output signal generated by the conversion circuit.

In some implementations, the signal of the battery that indicates a charge level of the battery includes a current signal of the battery or a voltage signal of the battery.

In some implementations, the signal of the battery that indicates a charge level of the battery is a voltage signal of the battery and the receiver controller is configured to determine that a relationship between the DC charging signal and the signal of the battery satisfies a predetermined criterion by (i) determining a target charging voltage based on the voltage signal of the battery and (ii) determining that a voltage level of the DC charging signal is less than the target charging voltage.

In some implementations, the signal of the battery that indicates a charge level of the battery is a current signal of the battery and the receiver controller is configured to determine that a relationship between the DC charging signal and the signal of the battery satisfies a predetermined criterion by (i) determining a target battery current and a threshold voltage level, (ii) determining that a current level of the current signal of the battery is less than the target battery current, and (iii) determining that a voltage level of the DC charging signal is less than the threshold voltage level.

In some implementations, generating a control signal to adjust the AC signal by the receiver controller includes generating a control signal to adjust the magnetic field. In some implementations, the receiver conversion circuit includes one or more switches and the receiver controller is configured to provide, to a transmitter, the control signal to adjust the magnetic field by generating a signal to change a state of one or more switches of the conversion circuit. In some implementations, the receiver also includes a communication module configured to electronically communicate with a transmitter and the receiver controller is configured to provide, to the communication module, the control signal to adjust the magnetic field.

In some implementations, a wireless charging system includes a transmitter configured to generate a magnetic field and a receiver, the receiver including an inductive coil, a charging circuit, a conversion circuit, and a controller. The receiver inductive coil is configured to generate an AC signal in the presence of the magnetic field generated by the transmitter. The conversion circuit is configured to convert the AC signal generated by the inductive coil to a DC output signal, where the voltage level of the DC output signal is a function of one or more characteristics of the AC signal generated by the inductive coil. The charging circuit is configured to convert the DC output signal to a DC charging signal, where the voltage level of the DC charging signal has a fixed relationship to the voltage level of the DC output signal and the voltage level of the DC charging signal is less than the voltage level of the DC output signal. The charging circuit is further configured to provide the DC charging signal to a battery. The controller is configured to (i) measure a signal of the battery that indicates a charge level of the battery; (ii) based on the signal of the battery, determine that a relationship between the signal of the battery and the DC charging signal satisfies a predetermined criterion; and (iii) based on determining that the relationship between the DC charging signal and the signal of the battery satisfies the predetermined criterion, generate a control signal to adjust the magnetic field. The receiver is further configured to provide the control signal to adjust the magnetic field to the transmitter.

In some implementations, a method for wirelessly charging a battery includes (i) measuring, by a controller, a signal of the battery that corresponds to a charge level of the battery, (ii) receiving, by the controller, a signal representing a characteristic of a DC charging signal, where the DC charging signal is generated by a receiver, (iii) based on the signal of the battery and the signal representing the characteristic of the DC charging signal, determining, by the controller, that a relationship between the DC charging signal and the signal of the battery satisfies a predetermined criterion; and (iv) based on determining that the relationship between the DC charging signal and the signal of the battery satisfies the predetermined criterion, generating, by the controller, a control signal to adjust the AC signal. Here, the receiver can include (i) an inductive coil configured to generate an AC signal in the presence of a magnetic field; (ii) a conversion circuit configured to convert the AC signal generated by the inductive coil to a DC output signal, where a voltage level of the DC output signal is a function of one or more characteristics of the AC signal generated by the inductive coil, and (iii) a charging circuit configured to (a) convert the DC output signal to the DC charging signal, where a voltage level of the DC charging signal has a fixed relationship to the voltage level of the DC output signal and the voltage level of the DC charging signal is less than the voltage level of the DC output signal; and (b) provide the DC charging signal to the battery. In some implementations, the signal representing a characteristic of a DC charging signal comprises a signal representing a current level or a voltage level of a DC charging signal.

Certain implementations have particular features and advantages. By implementing a wireless charging receiver with a switched-capacitor circuit to convert an input DC signal to a DC charging signal, the receiver may realize greater efficiency relative to some other approaches (e.g., a switched-mode power supply (SMPS) charging circuit). The receiver may thereby reduce power loss and allow the device to charge the battery at higher currents for longer times without risking device damage due to elevated temperatures.

Additionally, the voltage conversion ratio of the high-efficiency charging circuit can be selected to achieve various design objectives. For example, in some implementations, a switched-capacitor charging circuit with a 2:1 voltage conversion ratio (e.g., a voltage divider) may be selected to increase the intrinsic efficiency of the charging circuit. In other implementations, where the power loss through the receiver's inductive coil is of concern, a switched-capacitor charging circuit with a greater voltage conversion ratio (e.g., 4:1) may be selected. While a 4:1 switched-capacitor circuit may be less intrinsically efficient than a 2:1 circuit, the greater step-down ratio means that, for a given DC charging signal, the receiver components prior to the charging circuit operate at higher voltages, and thus lower currents. As the loss of the inductive coil generally depends strongly on current flow, operating at lower current levels can substantially decrease power loss through the inductive coil, which can increase the overall efficiency of the receiver.

The details of one or more implementations are set forth in the accompanying drawings and the description below. Other potential features and advantages of the disclosure will be apparent from the description, the drawings, and the claims.

### BRIEF DESCRIPTION OF THE DRAWINGS

FIG. 1 is a diagram illustrating an example of a high-efficiency wireless charging system.

FIGS. 2A-2B are block diagrams illustrating examples of a high-efficiency wireless charging system.

FIG. 3 is a diagram illustrating an example of switched-capacitor divider.

FIG. 4 is a flowchart illustrating an example of a method for high-efficiency wireless charging.

Like reference numbers and designations in the various drawings indicate like elements.

### DETAILED DESCRIPTION

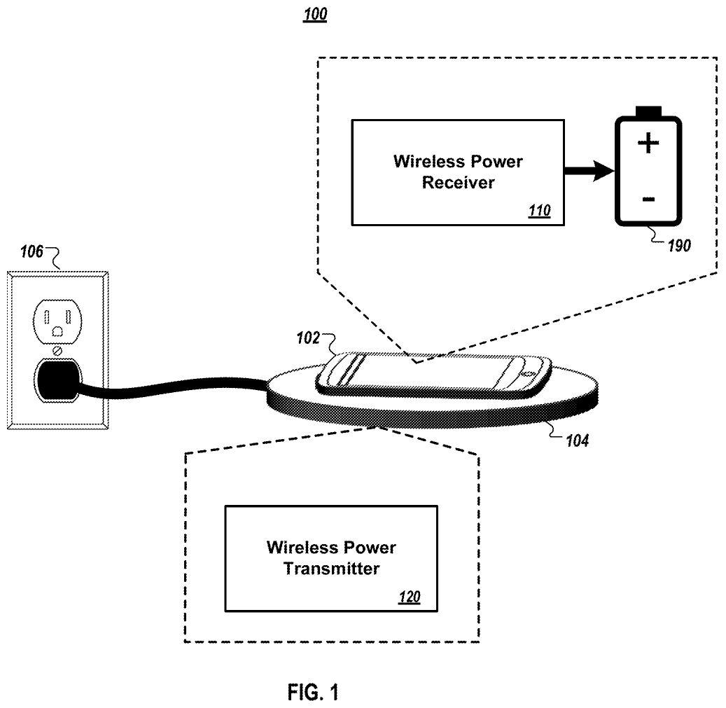

FIG. 1 is a diagram illustrating an example of a high-efficiency wireless charging system 100 for charging the battery of a mobile electronic device. The system 100 includes a charger 104 that connects to a power source 106. Using power provided by the power source 106, a power transmitter 120 of the charger 104 generates a wireless, transmitted power signal. The system 100 also includes a battery-powered electronic device 102 that incorporates a wireless power receiver 110 for delivering power to a rechargeable battery 190. When placed in close proximity to the charger 104, the receiver 110 of the device 102 converts the transmitted power signal to a DC charging signal that is provided to the battery 190 to replenish its charge. By wirelessly transferring power from the charger 104 to the electronic device 102, the battery 190 can be charged without physically connecting the device 102 to a power source.

The charger 104 is an electronic device that converts electrical power from a power source 106 to a transmitted power signal. The charger 104 can receive power from any of various sources 106, including a battery source or AC wall power. In the example system 100 of FIG. 1, the charger 104 receives power via an AC electrical signal provided through a cable connected to a wall outlet 106.

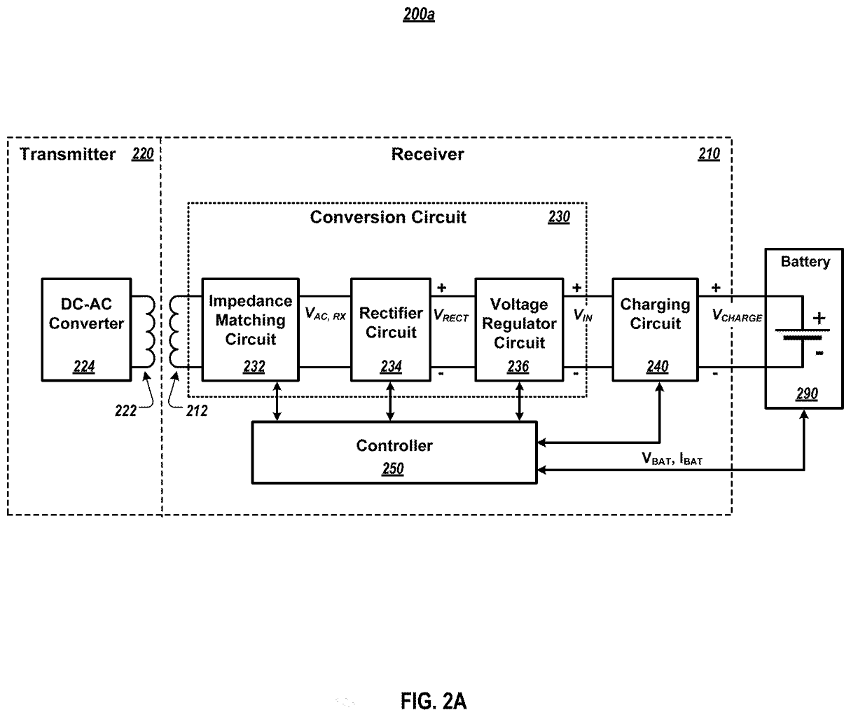

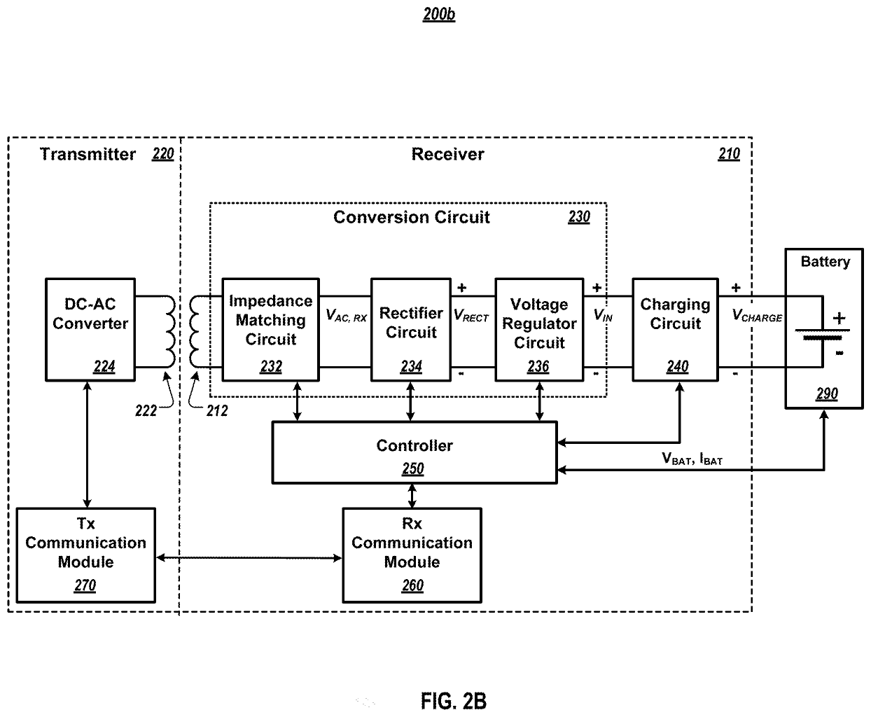

The charger 104 includes a wireless power transmitter 120 that generates a transmitted power signal. The transmitted power signal can be, for example, a magnetic field generated by a transmitting coil or an electromagnetic field generated by an electronic transmitter. In some implementations, the transmitted power signal has a frequency in the radio-frequency (RF) range, preferably from 100 kHz to 10 MHz. An example of a wireless power transmitter 120 is described in greater detail in FIG. 2A.

The system 100 also includes the electronic device 102. The electronic device 102 can be, for example, a smart phone, a cellular phone, a tablet computing device, a wearable device (e.g., a smart watch or wearable health monitor), or another battery-powered electronic device capable of wireless power reception. In some implementations, the charger 104 includes a substantially flat top surface on which the electronic device 102 can be placed.

The device 102 includes a high-efficiency wireless power receiver 110, which is configured to generate an AC signal in response to the transmitted power signal. For example, in some implementations, the transmitted power signal is a magnetic field generated by one or more inductive coils of the transmitter 120, and the receiver 110 includes one or more inductive coils that a resonance-matched to the transmitting coil. When the device 102 is placed on the surface of the charger 104, the device's receiving coil is in close proximity to, but not in direct contact with, the charger's transmitting coil, such that the coils are inductively coupled. As a result of the inductive coupling, the magnetic field generated by the transmitter 120 induces a corresponding AC signal in the receiver 110. The generated AC signal is then converted by various circuits of the receiver 110 to a DC charging signal that is provided to the device battery 190. An example of a wireless receiver 110 is described in greater detail in FIG. 2A.

The rechargeable battery 190 can be housed within the device 102 and provides the power necessary for various device operations. The battery 190 can be any of various types, including a Lithium-ion (Li-ion) battery, a Lithium-ion polymer (Li-polymer) battery, a Nickel-Cadmium (NiCd) battery, a Nickel-metal-hydride (NiMH) battery, or another rechargeable battery technology. The battery 190 is connected to the receiver 110 and is configured to receive the generated DC charging signal. Over time, the charge provided by the DC charging signal gradually increases the charge level of a depleted or discharged battery 190, such that at the end of a charging cycle, the battery 190 can be restored to full, or nearly-full, charge.

In some implementations, the receiver 110 adjusts the voltage level of the DC charging signal in response to a change in the charge level of the battery 190. For example, battery charging techniques may divide each charging cycle into at least two stages based on the battery charge level: (1) a fast-charging stage used when the battery charge level is low and (2) a slow-charging stage used when the battery charge level is near full charge. During the fast-charging stage when the battery charge level is low, the battery is charged using a constant-current DC signal, which allows for a relatively expedient restoration of charge. However, for batteries near full charge, constant-current charging risks the possibility of over-charging the battery, which can reduce battery performance and lifetime. As a result, when the battery charge level reaches a predetermined level, the charging system switches to a slow-charging stage, in which the battery is charged by a constant-voltage DC signal. Though the battery is charged more slowly by the constant-voltage signal, the risk of over-charging is eliminated or reduced. Because a battery's voltage gradually increases as it is charged, maintaining a constant charging current during the fast-charging stage involves gradually increasing the voltage level of the DC charging signal.

To adjust the voltage level of the DC charging signal in response to the charge level of the battery 190, the receiver 110 can send a message to the transmitter 120 to adjust the characteristics of the transmitted power signal. For example, to increase the voltage level of the DC charging signal, the transmitter 120 can shift the frequency of the generated magnetic field closer to resonance, which strengthens the coupling between the transmitting and receiving coils and increasing the voltage level of the AC signal generated by the receiver 110. Similarly, to decrease the voltage level of the DC charging signal, the transmitter 120 can shift the frequency of the magnetic field further from resonance, reducing the coupling between the coils and decreasing the voltage level of the generated AC signal.

In some implementations, the receiver 110 sends messages to the transmitter 120 by varying the receiver's input impedance, which the transmitter 120 can sense through the inductively-coupled coils. For example, the receiver 110 can send QI-compliant digital communication messages by modulating the receiver's input impedance through switched capacitor networks.

In some implementations, the receiver 110 sends messages to the transmitter 120 through a separate wireless communication channel using a standard or custom communication protocol. For example, the receiver 110 can include a BLUETOOTH transceiver and send messages to the transmitter 120 according to the ALLIANCE FOR WIRELESS POWER (A4WP) standard.

FIG. 2A is a block diagram illustrating an example of a high-efficiency wireless charging system 200a. The charging system 200a includes a transmitter 220 that wirelessly transfers power to a receiver 210 through near-field inductive coupling. The transmitter 220 may be part of a wireless charging device, for instance, the charger 104 of FIG. 1, and includes a DC-AC converter 224 and a transmitting coil 222. The receiver 210 may be housed within a mobile electronic device, such as the device 102 of FIG. 1, and includes a receiving coil 212, a conversion circuit 230 and a charging circuit 240 for generating a DC charging signal that is provided to a rechargeable battery 290 of the device. Operation of the receiver components is managed by a controller 250 that exchanges data with the various components to monitor circuit function and direct circuit behavior. The receiver controller 250 can also generate signals for communicating with the transmitter 220. The circuitry of the transmitter 220 and the receiver 210 can be implemented in any combination of discrete components (e.g., assembled onto one or more circuit boards) and/or integrated components (e.g., one or more integrated circuits).

The transmitter 220 generates a transmitted power signal in the form of an alternating magnetic field by sending AC current through a transmitting coil 222. The coil 222 can include single or multi-coil configurations and in some examples may be substantially planar. In some implementations, the coil 222 includes an array of overlapping or non-overlapping coils to increase the lateral area from which the magnetic field is transmitted.

The transmitting coil 222 can be connected to an impedance network and/or various other circuits for controlling the characteristics of the generated magnetic field. For example, the transmitting coil 222 may be connected to one or more resonant circuits that determine a resonance frequency for the transmitter 220.

In some implementations, the AC signal provided to the transmitting coil 222 is produced by a DC-AC converter 224. The DC-AC converter 224 accepts as input a DC signal generated earlier in the transmission chain and provides as output an AC signal that controls the characteristics of the magnetic field transmitted by the coil 222. The transmitter 220 can vary the behavior of the DC-AC converter 224, or of other transmitter components, to adjust the characteristics of the generated field. For example, by controlling its components, the transmitter 220 can adjust a frequency of the field, an amplitude or intensity of the field, a duty-cycle of the field, a pulse pattern (e.g., pulse width) of the transmitted field, or a combination of these and/or other characteristics.

The field generated by the transmitting coil 222 can be any of various frequencies and preferably may have a frequency within an RF range of tens of kHz to hundreds of MHz. In some implementations the generated field has a frequency between 100 kHz and 200 kHz. In other implementations, the generated field can have a frequency of 6 MHz to 8 MHz.

The transmitter 220 wirelessly transfers power to the receiver 210 via inductive coupling of the generated magnetic field. To receive the power, the receiver 210 includes a receiving coil 212. The receiving coil 212 may be similar to the transmitting coil 222. For example, the receiving coil 212 can include single coil or multi-coil configurations, may include a coil array, and/or may be substantially planar.

When placed in close proximity of one another, the transmitting coil 222 and the receiving coil 212 form an inductive pair, similar to a transformer. The mutual inductance of the pair results in a transfer of power from the transmitting coil 222 to the receiving coil 212, such that the alternating magnetic field generated by the transmitting coil 222 induces an AC electrical signal of the same frequency in the receiving coil 212.

The voltage level of the AC signal generated in the receiving coil 212 can depend on various factors, including the characteristics of the two coils (e.g., the mutual inductance of the coils, which in turn is dependent on the number of turns, the coil length, the coil material, and other factors), the separation between the two coils, and the frequency and/or intensity of the field generated by the transmitting coil 222. For example, the voltage level of the generated AC signal can generally be increased by reducing the distance between the two coils, increasing the intensity of the field, or shifting the frequency of the field closer to resonance.

The receiver 210 includes a conversion circuit 230, which converts the generated AC signal to a DC signal appropriate for input to the charging circuit 240. In system 200a, the conversion circuit 230 includes an impedance matching circuit 232, a rectifier circuit 234, and a voltage regulator circuit 236. The operation of the various components of the conversion circuit 230 is controlled by the controller 250.

Connected to the receiving coil 212 is the impedance matching circuit 232, which includes various resistive, capacitive, and inductive elements that, together with the receiving coil 212, determine the frequency response of the receiver 210. The matching circuit 232 can include, for example, one or more resonant circuits that determine a resonance frequency for the receiver 210 that matches the resonance frequency of the transmitter 220. The impedance matching circuit 232 outputs an AC signal, V_{AC,RX}, with a frequency that corresponds to the frequency of the alternating magnetic field generated by the transmitter 220.

In some implementations, the matching circuit 232 also includes variable and/or switched components for tuning or modifying the impedance and frequency response of the receiver 210. For example, the matching circuit 232 can include one or more switched capacitors for modulating the impedance of the circuit 232. The behavior of the matching circuit 232 can be adjusted by the controller 250, which can, for instance, provide signals to the circuit 232 that introduce or remove various switched components from the circuit's topology.

The conversion circuit 230 also includes the rectifier circuit 234, which converts the AC signal output by the matching circuit 232, V_{AC,RX}, to a DC electrical signal, V_{RECT}. The rectifier circuit 234 can include any of various circuitry appropriate for AC-DC rectification, including diode circuits such as a full-wave or half-wave bridge rectifier.

In some implementations, the rectifier circuit 234 includes one or more active rectification circuits (e.g., switching rectifiers), for converting the AC signal V_{AC,RX} to the DC signal V_{RECT}. Active rectification circuits, which use transistors or other switches rather than, or in addition to, diodes, can be advantageous to reduce power loss during the signal conversion. In receiver 210, the transistor switches of a switching rectifier circuit 234 can be controlled by the receiver controller 250 to achieve efficient operation.

After rectification, the DC signal V_{RECT} may be input to a voltage regulator circuit 236. The voltage regulating circuit 236 can be, for example, a linear regulator, such as a low-dropout regulator (LDO), a switching regulator, or another circuit configuration that outputs a stable, low-ripple DC voltage, V_{IN}, to be input to the charging circuit 240. In some implementations, the behavior of the voltage regulating circuit 236 can be adjusted by one or more control signals provided by the controller 250. For example, the controller 250 can provide a signal that selects between multiple voltage levels that can be output by the regulating circuit 236.

In some implementations, the conversion circuit 230 can include additional circuitry to condition or transform a received, generated, or converted signal. For example, the conversion circuit 230 can include one or more filter circuits (e.g., low pass filters), additional matching circuits, additional AC-DC and/or DC-DC conversion circuits, control circuits, power delivery circuits, or power management circuits.

The regulated DC signal V_{IN} generated by the conversion circuit is input to the charging circuit 240. The charging circuit 240 performs DC-DC step-down conversion to generate a DC charging signal, V_{CHARGE}, that is appropriate for charging the device battery 290. To achieve high-efficiency, the charging circuit 240 can be a switched-capacitor circuit that provides a fixed step-down DC-DC voltage conversion, such that the DC voltage level of the output signal V_{CHARGE} is less than the DC voltage level of V_{IN}. Because the charging circuit 240 has a fixed voltage conversion ratio, as the voltage level of the input signal V_{IN} varies, the voltage level of the output signal V_{CHARGE} will similarly vary proportionally. The operation of the charging circuit 240 can be controlled or adjusted by one or more signals provided by the controller 250. For example, the controller 250 can provide signals for switching the capacitors of a switched-capacitor charging circuit 240.

The charging circuit 240 can be configured to provide any step-down DC-DC voltage conversion ratio N:1, where N is a value greater than one. In practice, the conversion ratio may be based on any value of N between 1 and 32. The voltage conversion ratio is a design parameter that can be selected in advance so that the circuit's output, V_{CHARGE}, is of an appropriate voltage level for charging the connected battery 290 (e.g., the conversion ratio can be selected such that the voltage level of V_{CHARGE} is approximately 4.2 V for charging a single-cell Li-ion battery). In some implementations, the charging circuit 240 can be implemented as an integrated circuit, for example, the DA9318 direct charger from Dialog Semiconductor.

In some implementations, the charging circuit 240 is a switched-capacitor voltage divider (i.e., a voltage conversion ratio of 2:1). When optimized, switched-capacitor dividers can achieve efficiencies of 97% or greater in some examples. As losses in the charging circuit 240 can account for 30-40% of the overall power loss of the receiver 210, the efficiency gained by using a switched-capacitor divider for the charging circuit 240 can substantially reduce the dissipated power loss through the receiver 210. The reduced power loss leads to reduced device heating and enables charging of the battery 290 using higher currents (and thus faster charging) for longer times while maintaining the device temperature within a safe operating range.

In some implementations, the charging circuit 240 may be a switched-capacitor circuit that provides a larger voltage conversion ratio (e.g., 4:1). While a 4:1 switched-capacitor circuit may be less intrinsically efficient than a switched-capacitor voltage divider, the larger conversion ratio means that, for a particular target charging voltage V_{CHARGE}, the voltage level of the signal V_{IN} generated by the conversion circuit 230, and provided as input to the charging circuit 240, can be higher. For some systems, operating the receiving coil 212 and the conversion circuit at higher voltages, and thus lower currents, can be advantageous. For example, as the power loss through the receiving coil 212 generally depends strongly on current level, operating at higher voltages and lower currents can substantially decrease the power loss through the coil 212, which can increase the overall efficiency of the receiver 210.

The DC charging signal V_{DC} output by the charging circuit 240 is provided to the battery 290. The battery 290 can be similar to the battery 190, for example, it can be a single-cell Li-ion battery for powering an electronic device. As the battery 290 is charged, its charge level will gradually increase.

In some implementations, the battery 290 can be charged in at least two stages: (1) a fast-charge stage at low battery charge levels, where the DC charging signal V_{CHARGE} is adjusted to maintain a constant charging current and (2) a slow-charge stage at higher battery charge levels, where the DC charging signal V_{CHARGE} is adjusted to maintain a constant charging voltage. The system may transition from constant-current fast-charging to constant-voltage slow current after the battery 290 has reached a predetermined threshold charge level.

To adjust the DC charging signal V_{CHARGE} in response to the changing charge level of the battery 290, the receiver 210 can communicate with the transmitter 220 to adjust the transmitted power signal. Adjusting the transmitted power signal (e.g., the magnetic field) can change the voltage level of the AC signal generated in the receiver 210. The changed voltage level then propagates through the conversion circuit, leading to a changed V_{IN} and thus a changed V_{CHARGE}.

In some implementations, the receiver 210 communicates with the transmitter 220 using the controller 250. As described above, the controller 250 provides electrical signals for controlling the operation of the various circuits of the receiver 210. For example, the controller 250 can provide signals for changing the impedance of the matching circuit 232 (e.g., by switching capacitors or other circuit components into or out of the circuit path), for controlling the switches of an active rectifier circuit 234, for selecting a voltage level for the signal output by the regulator circuit 236, or for controlling the operation of switched-capacitors in the charging circuit 240. In some implementations, the controller 250 also receives signals from the circuits of the receiver 210 (e.g., to monitors a voltage and/or current level of a signal).

In addition to controlling operation of the circuits of the receiver 210, the controller 250 can also monitor the charge level of the battery 290 and communicate with the transmitter 220 to adjust the charging signal V_{CHARGE} while the battery 290 is being charged.

For example, the controller 250 can sense or measure one or more battery signals that indicates a charge level of the battery 290. The battery signal can be a battery voltage V_{BAT} (e.g., the battery's open circuit voltage), a battery current I_{BAT} (e.g., the charging current), a battery resistance or another measure of battery charge level. In some implementations, the controller 250 may measure or receive other signals to determine the charge level of the battery 290, for example, a battery temperature.

Based on the measured battery signal, the controller 250 may determine that a relationship between the DC charging signal V_{CHARGE} and the battery signal satisfies a predetermined criterion. Then, based on that determination, the controller 250 can generate a control signal to communicate to the transmitter 220 that it should adjust the transmitted magnetic field.

For example, as the battery 290 and its charge level increases, the battery voltage measured by the controller 250 will also increase. To maintain constant-current charging as the battery voltage increases, the voltage level of the DC charging signal V_{CHARGE} must also increase.

In the constant-current charging stage, to monitor the charge level of the battery 290, the controller 250 may measure the battery current I_{BAT}, which corresponds to the charging current, and compare the battery current I_{BAT} to a target charging current (e.g., 3 A). If the measured battery current I_{BAT} is less than the target charging current, the controller 250 can generate a control signal to increase the voltage level of the charging signal V_{CHARGE}, such that the battery current I_{BAT} increases to the target current level. Similarly, if the measured battery current I_{BAT} is greater than the target charging current, the controller 250 can generate a control signal to decrease the voltage level of V_{CHARGE} such that I_{BAT} decreases to the target current.

The receiver 210 can provide the control signals generated by the controller 250 to the transmitter 220, which can then adjust a characteristic of the transmitted power signal to increase or decrease the voltage level of the DC charging signal V_{CHARGE}, as described in more detail below.

In some implementations, the controller 250 may monitor the charge level of the battery 290 by measuring the battery voltage V_{BAT}. For example, during the constant-current charging stage, the controller 250 may measure the battery voltage V_{BAT} and determine a target charging voltage based on V_{BAT}, where the target charging voltage corresponds to the DC charging voltage required to provide the target charging current level. If the controller 250 determines that the voltage level of the DC charging signal V_{CHARGE} is less than the target charging voltage, the controller 250 can determine that the V_{CHARGE} voltage level should be increased to maintain constant-current charging.

In some implementations, the controller 250 may increase the voltage level of the DC charging signal V_{CHARGE} as long as the V_{CHARGE} voltage level does not exceed a predetermined voltage threshold (e.g., 4.2 V), where the voltage threshold corresponds to a threshold charging voltage at which the system transitions from constant-current to constant-voltage charging. If the voltage level of the DC charging signal V_{CHARGE} meets or exceeds the threshold level, the controller 250 may generate one or more control signals to indicate that the voltage level of the DC charging signal V_{CHARGE} should be maintained at a particular constant-voltage level. In some implementations, the controller 250 transition from constant-current to constant-voltage stages based on the measured charge level of the battery 290 (e.g., the controller 250 transitions to constant voltage charging when the measured battery charge level reaches a predetermined threshold charge level).

To adjust the voltage level of the DC charging signal V_{CHARGE}, the receiver 210 sends a message to the transmitter 250 to adjust the transmitted power signal. For example, the receiver 210 can provide the one or more control signals generated by the controller 250 to the transmitter 250, which can then adjust one or more characteristics of the transmitted power signal to increase or decrease the voltage level of the DC charging signal V_{CHARGE}.

In response to a message from the receiver 210 to increase the V_{CHARGE} voltage level, the transmitter 220 can, for example, increase the voltage level of the AC signal applied to the transmitting coil 222, which results in a corresponding increase in the voltage level of the AC signal generated in the receiver 210. Alternatively, the transmitter 220 can shift the frequency of the transmitted magnetic field closer to resonance, strengthening the coupling between the transmitting coil 222 and the receiving coil 212 and thus increasing the voltage level of the generated AC signal. In some implementations, the transmitter 220 can adjust other parameters of the transmitted power signal, such as a duty cycle, a pulse width, or another parameter to increase the voltage level of the power signal received by the receiver 210. The increase in the voltage level of the AC signal propagate through the receiver conversion circuit 230 and charging circuit 240, leading to the desired increase in V_{CHARGE} voltage level and a corresponding increase in battery current I_{BAT}.

The controller 250 of the receiver 210 can communicate with the transmitter 220 through any of various means. In the system 200a of FIG. 2A, the controller 250 can modulate the impedance of the matching circuit 232 by controlling the state of one or more switches of the circuit 232 (e.g., by switching capacitive or other components into or out of the circuit path). The transmitter 220 can sense the impedance modulation through the coupled coils and can decode the modulation to interpret the receiver's message. In some implementations, the controller 250 may digitally modulate the impedance according to a particular standard (e.g., amplitude-shift keying according to the QI standard). In some implementations, the transmitter can similarly send messages to the receiver 210 by modulating the transmitted power signal (e.g., frequency-shift keying or another modulation method), which the controller 250 or another receiver 210 component can sense and decode.

In some implementations, the receiver 210 and the transmitter 220 communicate via a dedicated wireless communication channel. FIG. 2B is a block diagram illustrating an example of a high-efficiency wireless charging system 200b where the receiver 210 includes a receiver communication module 260 and the transmitter 210 includes a transmitter communication module 270 for wirelessly exchanging data.

The communication modules 260 and 270 can each include a transceiver, allowing the transmitter 220 and the receiver 210 to exchange data related to the battery charging operation via BLUETOOTH or another wireless data protocol. In some implementations, the communication modules 260 and 270 exchange data according to the A4WP wireless power communication standard.

In the example system 200b, the receiver communication module 260 can receive data from the controller 250 indicating that the voltage level of the DC charging signal V_{CHARGE} should be increased or decreased. The communication module 260 can then send a message to the transmitter communication module 270 via the wireless communication channel indicating that the transmitted power signal should be adjusted.

After receiving the message from the receiver 210, the transmitter communication module 270 can relay the message to the DC-AC converter 224 of the transmitter 220 or to another transmitter 220 component, causing the transmitter 220 to adjust the generated field to increase or decrease the transmitted power signal.

In some implementations, the receiver 210 can change the voltage level of the DC charging signal V_{CHARGE} without communicating with the transmitter 220. For example, the controller 250 may be able to adjust the impedance of the matching circuit 232 to change the frequency response of the receiver 210. If the transmitted power signal remains unchanged, the changed frequency response can alter the voltage level of the generated AC signal, which then propagates to a change in V_{CHARGE} voltage level. Similarly, the other circuits of the conversion circuit (e.g., the rectifier circuit 234 and the regulating circuit 236) may include selectable components that allow the controller 250 to alter the V_{CHARGE} voltage level without communicated with the transmitter 220.

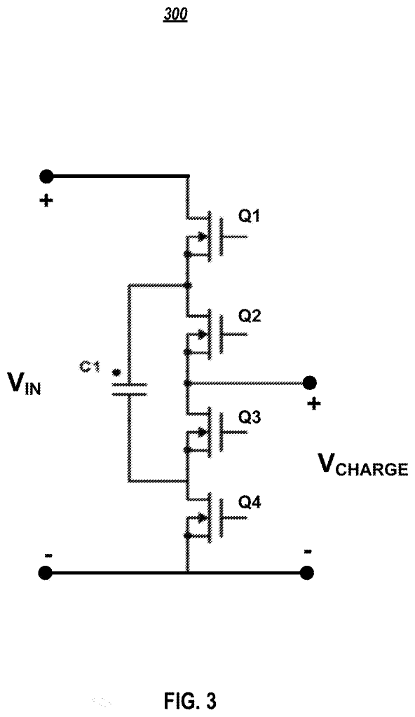

FIG. 3 is a diagram illustrating an example of a switched capacitor divider 300, such as may be included in the high-efficiency charging circuit 240 of the wireless charging systems 200a and 200b. The example switched capacitor divider 300 provides DC-DC voltage conversion at a fixed ratio of 2:1.

The divider 300 includes a capacitor C1 and four switches Q1, Q2, Q3, Q4 (“Q1-Q4”). The switches Q1-Q4 can be, for example, MOSFET or other transistor devices. By alternating between a first switch configuration (Q1, Q3 closed and Q2, Q4 open) and a second switch configuration (Q1, Q3 open and Q2, Q4 closed) at high frequencies (e.g., on the order of one MHz), the average output voltage V_{CHARGE} can be controlled to be one half the input voltage V_{IN}, giving rise to voltage divider functionality. In some implementations, the switched capacitor divider 300 may include or be followed by additional circuitry for signal conditioning, for example, one or more low pass filters for reducing the high-frequency content of the output voltage signal.

A controller, such as the controller 250 of systems 200a and 200b, can provide the synchronous control signals to the switches Q1-Q4 to drive operation of the circuit, with typical switching frequencies ranging from a few kHz to tens of MHz.

In some implementations, the divider 300 includes additional components for filtering, regulation, or other signal conditioning operations. The divider 300 can be assembled from discrete components or may be implemented as in a semiconductor-based integrated circuits.

The divider 300 is simply one example of the various switched capacitor and charge pump circuits that can comprise the high-efficiency charging circuit, with numerous other configurations, circuit topologies, and DC-DC voltage conversion ratios included within the scope of this disclosure. For example, the charging circuit can include ladder-type, Dickson charge-pump, or other switched capacitor configurations.

Because of the low loss of switched-capacitor topologies, charging circuits based on switched-capacitor configurations like that of divider 300 can be highly-efficient, providing DC-DC conversion at fixed conversion ratio with high efficiency.

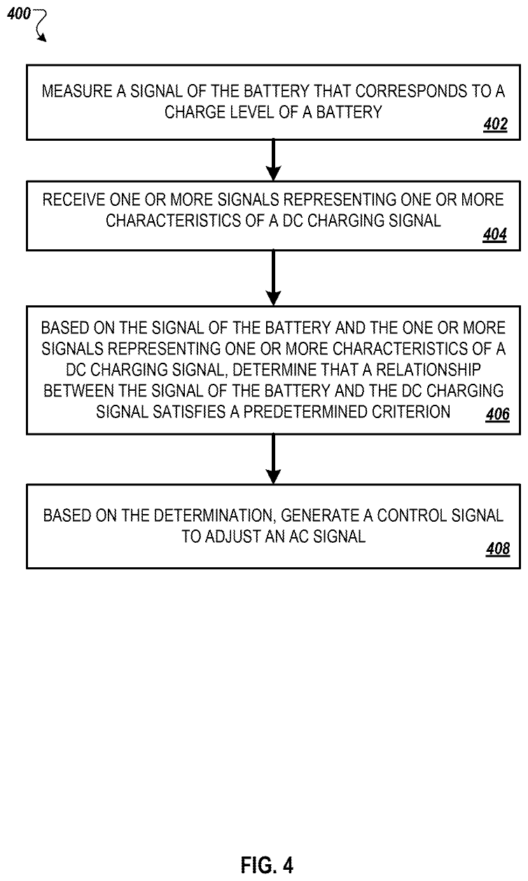

FIG. 4 is a flowchart illustrating an example of a method 400 for high-efficiency wireless charging. The method 400 can be performed by a receiver controller, such as the controller 250, or another electronic control device. Briefly, the method includes measuring a signal of a battery that corresponds to a charge level of the battery (402); receiving one or more signals representing one or more characteristics of a DC charging signal (404); based on the signal of the battery and the one or more signals representing one or more characteristics of a DC charging signal, determining that a relationship between the signal of the battery and the DC charging signal satisfies a predetermined criterion (406); and based on the determination that the relationship satisfies a predetermined criterion, generating a control signal to adjust an AC signal (408).

In more detail, t the method includes measuring, by a controller, a signal of a battery that corresponds to a charge level of the battery (402). The controller can be part of a wireless power receiver, for example, the wireless power receiver 210 of systems 200a and 200b, which is part of an electronic device such as a smartphone, a tablet computing device, a digital audio player, a wearable health monitor, a smart watch, or another mobile computing device. The wireless receiver is configured to convert a received wireless power signal to a DC charging signal for charging a device battery. The wireless power signal can be, for example, an alternating magnetic field or an electromagnetic field generated by a nearby wireless power transmitter. The DC charging signal generated by the wireless receiver is provided to the device battery, e.g., a rechargeable Li-ion battery that provides power to the electronic device.

The controller can measure one or more of various signals of the rechargeable device battery, including a battery voltage, a battery current, or a battery resistance. For example, the controller may measure the battery's open circuit voltage. Based on the measured battery signal, the controller can determine the battery's charge level (e.g., fully charged, fully discharged, 15% of full charge, etc.) at a particular time.

In some implementations, the controller may receive and use additional signals, such as a battery temperature, to determine a battery's charge level. In some implementations, the controller measures a signal of a battery that corresponds to the battery's charge level by receiving a signal from a measurement circuit, where the signal indicates a particular battery characteristic (e.g., the battery current, OCV, resistance) or an indication of the battery's charge level (e.g., a signal indicating that the battery is at 85% of full charge). The controller also receives one or more signals representing one or more characteristics of a DC charging signal (404). The DC charging signal can be generated by the wireless power receiver and is provided to the battery for charging. The one or more signals representing characteristics of the DC charging signal can indicate, for example, a current level or a voltage level of the DC charging signal.

The wireless power receiver can include various circuits for converting a transmitted power signal to the DC charging signal provided to the battery. In some implementations, the wireless receiver includes (i) an inductive coil, (ii) a conversion circuit, and (iii) a charging circuit. The receiver inductor coil can be, for example, a substantially-planar single- or multi-layer wire coil integrated into the electronic device. The inductive coil is configured to generate an AC signal in the presence of an alternating magnetic field. The alternating magnetic field can be generated, for example, by a transmitting coil of a nearby wireless power transmitter, such as the transmitter 220 of systems 200a and 200b.

The receiver conversion circuit is configured to convert the AC signal generated by the inductive coil to a DC output signal that is provided to the charging circuit. The voltage level of the DC output signal is a function of one or more characteristics of the AC signal generated by the inductive coil, for example, the DC output signal voltage level may be a function of the AC signal's voltage level, frequency, duty cycle, pulse width, or other signal characteristic.

In some implementations, the receiver conversion circuit includes an impedance matching circuit, a rectifying circuit, and a voltage regulating circuit. The impedance matching circuit may connect or couple to the inductive coil and may modify the AC frequency response of the receiver. For example, the impedance matching circuit may include a resonant circuit that determines a resonant AC frequency for the receiver. The impedance matching circuit can provide the AC signal generated by the inductive coil for output to the rectifying circuit of the conversion circuit.

The rectifying circuit converts the AC signal generated by the inductive coil to a DC signal. The rectifying circuit can include one or more of various circuit configurations and can include passive and/or active rectification circuit topologies. For example, the rectifying circuit can include one or more of a full-wave diode bridge rectifier or an active switching rectifier.

The rectifying circuit provides the DC signal to the voltage regulating circuit, which can generate a regulated DC output signal. The regulating circuit can be, for example, a linear voltage regulator or a switching voltage regulator, which outputs a low-ripple DC output signal that is provided as input to the charging circuit.

The charging circuit is configured to convert the DC output signal generated by the conversion circuit to a DC charging signal that is provided to the battery. The charging circuit includes a DC-DC step-down converter, where the voltage level of the generated DC charging signal is less than the voltage level of the DC output signal provided to the charging circuit. Furthermore, the voltage level of the generated DC charging signal has a fixed relationship to the voltage level of the DC output signal provided to the charging circuit. In some implementations, the voltage level of the generated DC charging signal may be reduced from the voltage level of the DC output signal by a fixed ratio of N:1, where N is a value greater than one. For example, the voltage level of the generated DC charging signal can be one half (e.g., N=2) or one quarter (e.g., N=4) of the voltage level of the DC output signal.

In some implementations, the charging circuit is a high-efficiency charging circuit that includes one or more switched capacitor circuits. For example, the charging circuit can include a switched capacitor divider, a switched-capacitor charge pump circuit, or another switched-capacitor circuit configuration.

Based on the signal of the battery and the one or more signals representing one or more characteristics of a DC charging signal, the controller determines that a relationship between the signal of the battery and the DC charging signal satisfies a predetermined criterion (406). If the controller determines that the relationship between the battery signal and the DC charging signal satisfies the criterion, it can determine that the voltage level of the DC charging signal should be adjusted.

For example, in some implementations, the controller measures a current signal of the battery and further determines a target battery current. The target battery current may be, for example, a target charging current (e.g., 3 A) for the battery during a constant-current charging stage. The controller also determines a threshold voltage level (e.g., 4.2 V), where the threshold voltage level corresponds to a charging voltage at which the wireless charging system transitions from constant-current to constant-voltage battery charging.

The controller determines that the relationship between the battery signal and the DC charging signal satisfies the predetermined criterion by determining (i) that the current level of the battery current signal is less than the target battery current (e.g., that the present charging current is less than the target charging current level) and (ii) that a voltage level of the DC charging signal is less than the threshold voltage level (e.g., the DC charging voltage is less than the voltage threshold for transitioning to constant-voltage charging). In this example, because the criterion is satisfied, the controller determines that the voltage level of the DC charging signal should be increased to maintain constant-current charging of the battery.

As another example, in some implementations, the controller measures a voltage signal of the battery and, based on the voltage signal of the battery, determines a target charging voltage. The target charging voltage can, for example, correspond to the DC charging signal voltage level necessary to maintain a target charging current for the battery. In this example, the controller determine that the relationship between the battery signal and the DC charging signal satisfies the predetermined criterion by determining that the voltage level of the DC charging signal is less than the target charging voltage. Because the criterion is satisfied, the controller determines that the voltage level of the DC charging signal should be increased to maintain constant-current charging of the battery.

Finally, based on the determination that the relationship satisfies a predetermined criterion, the controller generates a control signal to adjust the AC signal generated by the receiver (408). By adjusting the AC signal generated by the receiver, the voltage level of the DC charging signal provided to the battery can be adjusted.

In some implementations, the control signal generated by the controller is provided to the nearby wireless transmitter and indicates that the transmitter should adjust one or more characteristics of the alternating magnetic field so that the AC signal generated by the receiver is appropriately modified. For example, to increase the AC signal generated by the receiver, the transmitter can increase the intensity of the magnetic field, or shift the frequency of the magnetic field closer to the resonance of the receiver.

In some implementations, the receiver provides the control signal to the transmitter by modulating the receiver impedance sensed by the transmitter. For example, the impedance matching circuit of the receiver conversion circuit can include one or more switches, where the switches enable one or more circuit elements to be placed into or out of the circuit path. By changing the state of one or more of the switches of the conversion circuit, the controller can modulate the receiver impedance, which can be sensed by the transmitter. The transmitter can then decode the modulated impedance to receive the control signal generated by the controller.

In some implementations, the receiver includes a dedicated communication module configured to electronically communicate with the transmitter. For example, the receiver can include a transceiver for sending and receiving wireless data according to the BLUETOOTH transmission protocol. The receiver can provide the control signal to adjust the magnetic field to the communication module, which can then electronically send it to the transmitter.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A receiver for a wireless charging system comprising:
an inductive coil configured to generate an AC signal in the presence of a magnetic field;
a conversion circuit configured to convert the AC signal generated by the inductive coil to a DC output signal, wherein a voltage level of the DC output signal is a function of one or more characteristics of the AC signal generated by the inductive coil;
a charging circuit configured to:
convert the DC output signal to a DC charging signal, wherein the voltage level of the DC charging signal has a fixed relationship to the voltage level of the DC output signal and the voltage level of the DC charging signal is less than the voltage level of the DC output signal; and
provide the DC charging signal to a battery; and
a controller configured to:
measure a signal of the battery that corresponds to a charge level of the battery;
based on the signal of the battery, determine that a relationship between the DC charging signal and the signal of the battery satisfies a predetermined criterion; and
based on determining that the relationship between the DC charging signal and the signal of the battery satisfies the predetermined criterion, generate a control signal to adjust the AC signal.

2. The receiver of claim 1, wherein the conversion circuit comprises:
an impedance matching circuit;
a rectifying circuit; and
a voltage regulating circuit.

3. The receiver of claim 2, wherein the rectifying circuit comprises one or more of a full-wave diode bridge rectifier or an active switching rectifier.

4. The receiver of claim 2, wherein the voltage regulating circuit comprises one or more of a linear voltage regulator or a switching voltage regulator.

5. The receiver of claim 1, wherein the voltage level of the DC output signal is determined based on one or more characteristics of the AC signal generated by the inductive coil comprises the voltage level of the DC output signal is determined based on one or more of a voltage level of the AC signal or a frequency of the AC signal.

6. The receiver of claim 1, wherein the charging circuit comprises one or more switched capacitor circuits.

7. The receiver of claim 1, wherein the voltage level of the generated DC charging signal is one half or one quarter of the voltage level of the DC output signal.

8. The receiver of claim 1, wherein the signal of the battery that indicates a charge level of the battery comprises a current signal of the battery or a voltage signal of the battery.

9. The receiver of claim 1, wherein
the signal of the battery that indicates a charge level of the battery is a voltage signal of the battery; and
determining that a relationship between the DC charging signal and the signal of the battery satisfies a predetermined criterion comprises:
determining a target charging voltage based on the voltage signal of the battery; and
determining that a voltage level of the DC charging signal is less than the target charging voltage.

10. The receiver of claim 1, wherein
the signal of the battery that indicates a charge level of the battery is a current signal of the battery; and
determining that a relationship between the DC charging signal and the signal of the battery satisfies a predetermined criterion comprises:
determining a target battery current and a threshold voltage level;
determining that a current level of the current signal of the battery is less than the target battery current; and
determining that a voltage level of the DC charging signal is less than the threshold voltage level.

11. The receiver of claim 1, wherein generating a control signal to adjust the AC signal comprises generating a control signal to adjust the magnetic field.

12. The receiver of claim 11, wherein:
the conversion circuit comprises one or more switches; and
the controller is further configured to provide, to a transmitter, the control signal to adjust the magnetic field by generating a signal to change a state of one or more switches of the conversion circuit.

13. The receiver of claim 11, further comprising:
a communication module configured to electronically communicate with a transmitter; and
wherein the controller is further configured to provide, to the communication module, the control signal to adjust the magnetic field.

14. A wireless charging system comprising:
a transmitter configured to generate a magnetic field; and
a receiver comprising:
an inductive coil configured to generate an AC signal in the presence of the magnetic field;
a conversion circuit configured to convert the AC signal generated by the inductive coil to a DC output signal, wherein the voltage level of the DC output signal is a function of one or more characteristics of the AC signal generated by the inductive coil;
a charging circuit configured to:
convert the DC output signal to a DC charging signal, wherein the voltage level of the DC charging signal has a fixed relationship to the voltage level of the DC output signal and the voltage level of the DC charging signal is less than the voltage level of the DC output signal; and
provide the DC charging signal to a battery; and
a controller configured to:
measure a signal of the battery that indicates a charge level of the battery;
based on the signal of the battery, determine that a relationship between the signal of the battery and the DC charging signal satisfies a predetermined criterion; and
based on determining that the relationship between the DC charging signal and the signal of the battery satisfies the predetermined criterion, generate a control signal to adjust the magnetic field;
wherein the receiver is configured to provide the control signal to adjust the magnetic field to the transmitter.

15. The system of claim 14, wherein:
the signal of the battery that indicates a charge level of the battery is a voltage signal of the battery; and
determining that a relationship between the DC charging signal and the signal of the battery satisfies a predetermined criterion comprises:
determining a target charging voltage based on the voltage signal of the battery; and
determining that a voltage level of the DC charging signal is less than the target charging voltage.

16. The system of claim 14, wherein:
the signal of the battery that indicates a charge level of the battery is a current signal of the battery; and
determining that a relationship between the DC charging signal and the signal of the battery satisfies a predetermined criterion comprises:
determining a target battery current and a threshold voltage level;
determining that a current level of the current signal of the battery is less than the target battery current; and
determining that a voltage level of the DC charging signal is less than the threshold voltage level.

17. The system of claim 14, wherein:
the conversion circuit further comprises one or more switches; and
the receiver is configured to provide the control signal to adjust the magnetic field to the transmitter by changing a state of one or more of the switches of the conversion circuit.

18. The system of claim 14, wherein:
the receiver further comprises:
a communication module configured to electronically communicate with the transmitter; and
the receiver is configured to provide the control signal to adjust the magnetic field to the transmitter by providing the control signal to adjust the magnetic field to the communication module.

19. A method for wirelessly charging a battery, the method comprising:
measuring, by a controller, a signal of the battery that corresponds to a charge level of the battery;
receiving, by the controller, a signal representing a characteristic of a DC charging signal, wherein the DC charging signal is generated by a receiver, the receiver comprising:
an inductive coil configured to generate an AC signal in the presence of a magnetic field;
a conversion circuit configured to convert the AC signal generated by the inductive coil to a DC output signal, wherein a voltage level of the DC output signal is a function of one or more characteristics of the AC signal generated by the inductive coil;
a charging circuit configured to:
convert the DC output signal to the DC charging signal, wherein a voltage level of the DC charging signal has a fixed relationship to the voltage level of the DC output signal and the voltage level of the DC charging signal is less than the voltage level of the DC output signal; and
provide the DC charging signal to the battery; and
based on the signal of the battery and the signal representing the characteristic of the DC charging signal, determining, by the controller, that a relationship between the DC charging signal and the signal of the battery satisfies a predetermined criterion; and
based on determining that the relationship between the DC charging signal and the signal of the battery satisfies the predetermined criterion, generating, by the controller a control signal to adjust the AC signal.

20. The method of claim 19, wherein the signal representing a characteristic of a DC charging signal comprises a signal representing a voltage level of a DC charging signal.
